(19) United States
(12) Patent Application Publication
(10) Pub. No.: US 2005/0239549 A1
(43) Pub. Date: Oct. 27, 2005

(54) MULTI-MEDIA ENHANCEMENT SYSTEM FOR FANTASY LEAGUES

(76) Inventors: Frank Salvatore, Lakewood, CO (US); William Given, Golden, CO (US)

Correspondence Address: GLENN L. WEBB, P.O BOX 951, CONIFER, CO, 80433, US

(21) Appl. No.: 10/709,300

(22) Filed: Apr. 27, 2004

(51) Int. Cl. G06F 19/00; G06F 17/00

(52) U.S. Cl. 463/42

(57) ABSTRACT

A1 multi-media enhancement for fantasy league operations. The present invention provides a multi-media enhancement for fantasy league operations such as the draft proceedings. A multi-media viewer displays audio, video and other information that relate to selected players as well as other related information or entertainment medium. The system can be used via DVD, CD as well as online or other network systems. It can be used as a stand alone fantasy draft system or to supplement other fantasy draft systems. Another enhancement may be used to allow team owners to download on-demand video and audio highlights to evaluate their players performance.

### BACKGROUND OF INVENTION

Fantasy sports have become a huge leisure activity for many sports enthusiasts. It is estimated that over thirty million individuals annually participate in some form of a fantasy sports league. These fantasy sports leagues cover many different sports including but not limited to professional football, basketball, baseball, soccer, rugby, cricket as well as other sports, professional as well as amateur.

Each of these fantasy sports leagues have common elements regardless of the sport that is being covered. A typical fantasy sports league will have a plurality of owners. Each owner will select or draft players from a pool in sequence to form their fantasy team. The performance of the fantasy team is normally measured by the actual performance of the teams players. This performance is measured against the performance of the players of the team against which the owners team is scheduled against within the league competition. The games are then won or lost accordingly.

The pool from which the players are selected or drafted is typically formed from the rosters of the teams of the actual league, such as the NFL, NBA, MLB or other sports leagues. A typical fantasy sports league will allow the owners to select in a predetermined order, such as random, previous league standings or some other mechanism. The owners will need to have some knowledge of the ability of the players remaining in the pool in order to have a competitive team. There are even cottage industries that specialize in rating the potential of a players performance in a given fantasy sports league.

One of the major events in a fantasy sports league is the draft night. This is often the only occasion when all of the owners will congregate, either in person or via the Internet or other networked system. These draft nights have become more elaborate and complex in order to enhance the enjoyment of the experience. However, the draft selection itself is somewhat anticlimactic, with the announcement of the name of the selected player. Often, the other owners may not be particularly aware of that player or the related statistics or career highlights of that player. Also, there is often dead time between the selections of players. This dead time often leads to a drop-off in interest in the proceeding.

There are presently computer software systems that are designed to implement fantasy sports drafts. These systems only provide a computer screen that lists the names of the players and assign them to a team once they have been drafted. There is little or no other information about that player offered during the draft selection.

Another feature of many fantasy sports leagues is that of a fantasy sports league manager. The fantasy sports league manager is now often a computer software system that manages the functions of the fantasy sports league. These functions may include the draft software, discussed above, as well as functions that allow teams to trade players, to waive and pick up players, to provide sports news and statistics about the league and to track scores and standings. This software may reside on a single user system or be a networked system. These systems only disseminate the information in the form of text as well.

Thus a need exists for providing information and highlights of players as well as other information during a fantasy sports league draft and during the league competition in a form that will enhance the experience for the fantasy sports participants.

### SUMMARY OF INVENTION

The present invention solves these and other problems by providing a system that adds informational and entertainment value to the draft proceedings for a fantasy league. The system is able to maintain interest in the draft proceedings during the dead time between selections as well as enhance the atmosphere during the selection process. The system can be implemented for any type of sports or other fantasy league operation. The system may also be implemented over existing technologies as well as over future technologies as they are developed.

The system in a preferred embodiment provides a display of the fantasy league draft proceeding to provide pertinent information relating to the proceeding, such as draft selection, team selecting, and other information. The present invention provides a media viewer as well that displays information in a multi-media format relating to the draft proceeding.

The system, in a preferred embodiment, provides multi-media information, such as audio and video highlights relating to the player being selected. Additional information regarding other players, either already selected or waiting to be selected, may also be viewed during the time between selections. Also, entertainment segments, sports trivia games or other clips may be viewed between selections.

The system, in another preferred embodiment, may also include advertisements, such as pop-ups, banners, clips, or even full length commercials during the draft proceeding.

The system may be implemented by existing computer or television systems with removable media such as compact discs, DVDs, or other types of media formats. The system may also be implemented on television entertainment systems, receivers, or electronic gaming systems.

The system also may be implemented through a server based system. The clients may be able to access the system by online access, network access, satellite services or handheld wireless devices.

In another embodiment of the present invention, a system for managing a fantasy league is utilized. The system may be a server based system that is accessible online, by a network, via satellite access, by handheld wireless devices or by any other type of access. The system is able to monitor the actual players performances, update statistics, calculate winners and losers, update standings, track trades, waivers, pickups and other player transactions.

In a preferred embodiment of this system, the system maintains multi-media clips of the actual players performance on a game by game basis. The individual team owners may retrieve the clips on an on-demand basis. The owners can then conduct film sessions and evaluate each players performance.

These and other features of the present invention will be evident from the ensuing detailed description of preferred embodiments, from the drawings and from the claims.

### BRIEF DESCRIPTION OF DRAWINGS

FIG. 1 is an illustration of a displayed screen of the system of a preferred embodiment of the present invention displaying the draft proceeding of a fantasy league.

FIG. 2 is an illustration of a displayed screen of the embodiment of FIG. 1 configuring the team rosters of the fantasy league.

FIG. 3 is an illustration of a displayed screen of the embodiment of FIG. 1 configuring the draft proceeding.

FIG. 4 is a schematic of the system of the embodiment of FIG. 1.

FIG. 5 is a schematic of an alternative embodiment of a fantasy league manager system.

### DETAILED DESCRIPTION

The present invention provides a multi-media enhancement system for fantasy leagues, such as sports leagues. It is to be expressly understood that the descriptive embodiments set forth herein are intended for explanatory purposes and is not intended to unduly limit the scope of the present inventions. Other embodiments and applications not described herein are considered to be within the scope of the invention. It is also to be expressly understood that while specific embodiments for the components of the system are discussed, other equivalents to these embodiments that perform substantially similar functions are within the scope of the claimed inventions.

A preferred embodiment of the present invention is intended for use either in a manually administered fantasy sports league or in connection with an automated or online administered fantasy sports league. This embodiment provides a multi-media fantasy sports draft system for use with any form of fantasy sports league. This embodiment provides an entertainment element that is lacking from existing draft systems.

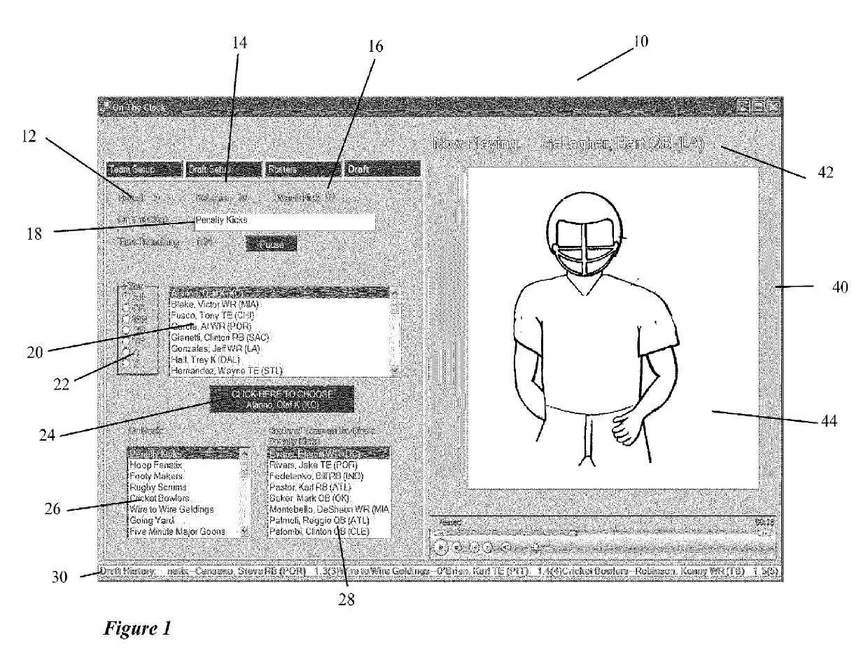

In a preferred embodiment of the present invention, a monitor, big-screen television or other type of screen displays the draft proceeding. An example of such a display is the screen shot illustrated in FIG. 1. This particular display provides information relating to the draft proceeding. It is to be expressly understood that other information or types of displays may be utilized under the present inventive concept.

Display 10 provides information relating to the status of the draft such as the Draft Round 12, the Selection Number 14, the Overall Pick Number 16, the name of the fantasy team that is currently selecting 18, a scrollable list of the names of available players 20, a filter for screening the players by position 22, a Selection button 24 for selecting a player, a List 26 of the next few teams in the order of their draft sequence, a Roster list 28 of players for each team, a scrollable ticker 30 of the Draft History, and a media player 40 with a caption heading 42.

This particular display is provided for exemplary purposes only and is not meant to limit the scope of the present invention. It is to be expressly understood that the present invention covers other types of screens and other types of information include in the screen.

The particular display 10 is displaying the following information. The fantasy sports team Penalty Kicks is currently selecting in the ninth round, at the tenth pick, at the ninetieth overall pick. That team currently has one minute and thirty-four seconds left to make their pick. The team is currently reviewing a list of all football players left to be drafted. Their current roster list is displayed in screen 28. The next few teams in the order of their draft sequence are displayed in screen 26. A scrolling list of the entire draft history up to that minute is scrolling by in screen 30.

A media display 44 is displayed in media player 40 of the screen 10. This media display may include information, highlights, bloopers or other information that relate to players in the draft pool. For example, media display 44 may include video and audio highlights of a player that is currently being selected. This highlight may include plays made by the player, interviews with player, interviews with coaches, scouts or opposing players regarding that player. The media display 44 may also include statistical information about that player. A caption describing the name of the player or the activity being viewed is provided in caption heading 42.

The media display 44 may also include information on players previously selected or players being considered for selection in order to fill the dead time between selections. The media display 44 may also provide other entertainment as well, such as bloopers, highlights, or even ongoing sports competition. Any other type of entertainment or educational media may be viewed as well under the present invention. For example, a sports trivia game may be viewed that allows participation and competition by the other owners or others viewing the screen.

The media player 40 can be special media player designed solely for use with the present invention or an off the shelf media player such as the Real Player by Real Networks, Media Player by Microsoft, Inc. or any number of other media players.

In another embodiment of the present invention, the draft management system also provides commercial advertising. The commercial advertising may include such formats as banner advertisements, pop-up advertisements, full screen advertisements, multi-media advertisements, full-length commercials, voice-over audio advertisements and any other suitable advertising formats. The advertisements can be particularly targeted to the fantasy sports league participants. For example, the advertisements may include advertisements for sports tickets for the particular type of fantasy sports, i.e., NFL tickets for fantasy football league participants, or other types of entertainment that may be of interest for those participants. Also local entertainment venues, restaurants, bars, sports memorabilia stores or other retail establishments may choose to advertise. Any other suitable retail or commercial operation may include advertising through this system.

The multi-media fantasy sports draft system of a preferred embodiment of the present invention may be produced with any number of different types of technology. The system may utilize a removable format medium such as a DVD and CD format medium to provide the system to users. The users, that is the fantasy sports league owners, may then use existing computers and/or television sets to view and interact with the screen. For example, a single computer system with a projection system may be used to allow the owners or an administrator to view and interact with the present system. It is to be expressly understood that the term computer shall mean not only stand alone computers such as desktops, notebooks, or any other type computer system but also dedicated systems that utilize computer processors, as well as networked computers. A large screen television with an entertainment or television-top receiver may be used. Also, game systems may include game packages that allow viewing of the present system as well as interaction with the system to conduct the draft. Other embodiments of the system of the present invention may include a server based system that may be used by multiple users via the Internet or other types of networks. Wireless technology may also be used to allow handheld device technology to be utilized to view and interact with the draft proceeding.

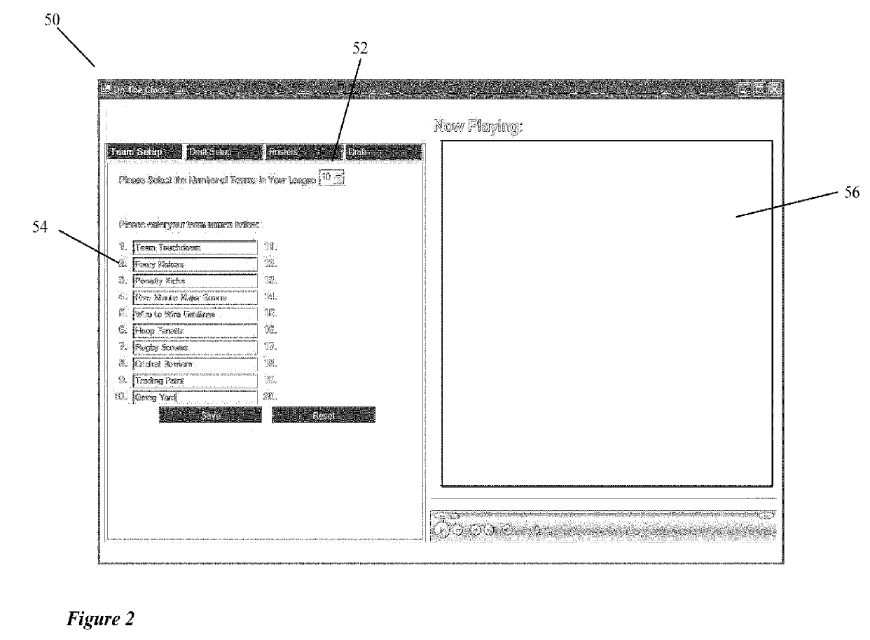

Another preferred embodiment of the present invention enables the system to be set up prior to the draft proceeding. This allows the fantasy sports league to be uniquely configured to the needs of the owners of the league. A screen shot of a configuration menu for one such system under this embodiment is illustrated in FIG. 2. This screen 50 includes an entry menu 52 that allows an administrator to select the numbers of teams in the leagues. Then entry menus 54 for the selected number of teams are then highlighted. The names of each team are then entered into those entry menus. This information is then stored for the draft proceeding discussed in screen 10 in FIG. 1. A media player 56 may be activated to display information, such as team names, logos, team colors, information about the team owner, highlights, bloopers or any other information. It is to be expressly understood that this exemplary embodiment is intended for descriptive purposes only and is not meant to limit the scope of the present invention.

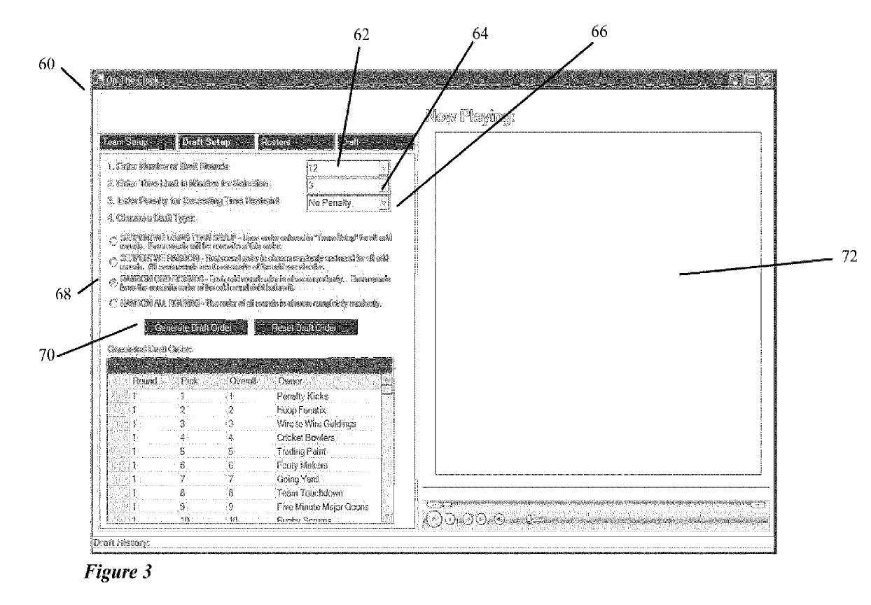

Another configuration menu, such as shown in screen 60 in FIG. 3, allows the draft proceeding itself to be uniquely configured to the needs of the owners of the fantasy league. In this particular embodiment, the screen 60 allows entry of the number of draft rounds in drop down menu 62, the time limit between rounds in drop down menu 64, and selection of penalties for too much time in drop down menu 66. The administrator may also select the Draft Type in selection menu 68. This particular embodiment also includes a Draft Order Generator 70 to select the order that the teams will select. Also, media player 72 may also be used to view information about the draft, the teams, the owners, the players in the pool, or other entertainment or educational information. Again, this embodiment is provided for descriptive purposes only and is not meant to limit the scope of the present invention.

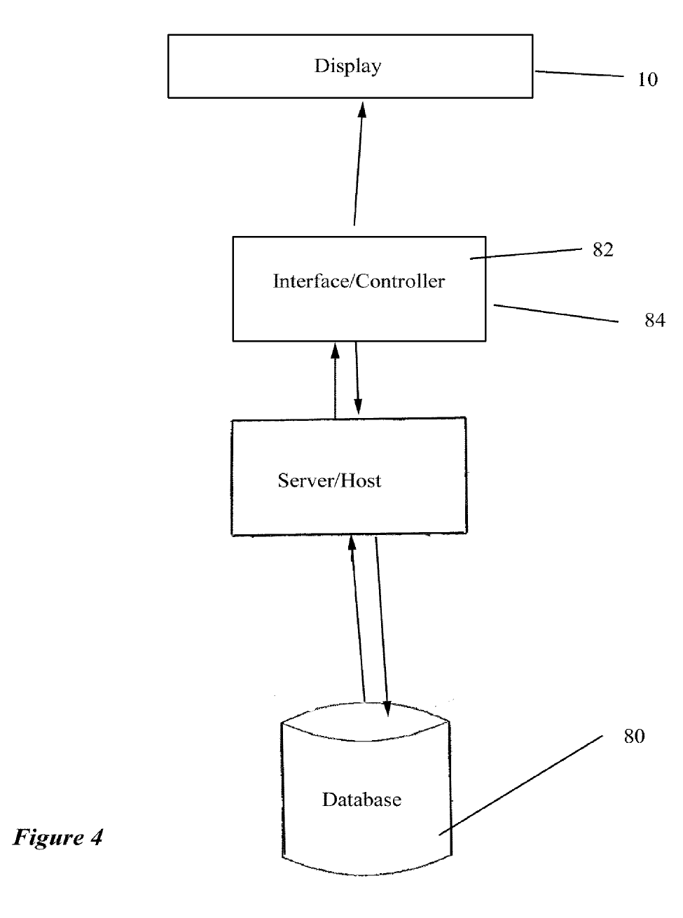

Once the team rosters have been set and the draft has been configured, the draft proceeding can begin, as shown in FIG. 1. This system can easily be configured for any type of sports fantasy league or other fantasy league operations. It can be implemented as a standalone system for manually administered fantasy leagues and for other stand-alone automatically administered fantasy leagues. It may also be used to supplement other fantasy league draft systems. As shown in the schematic illustrated in FIG. 4, the system includes a database 80 and an interface 82. It shall be expressly understood that the term database shall mean not only a computer storage database as that term is commonly used but also includes any type of data storage that may retain and store information. This term may also include a file system as well of the stored information that can be manually retrieved. The database 80 includes the audio, video, text and other media to be displayed in media player 40. The interface 82 includes a controller 84 and the screen 10 and communicates with database 80. As a player is selected, the controller 84 retrieves the media from database 80 for display in media player 40. The media player is activated to display the retrieved media. The controller may also randomly display media from database 80, display requested media, display advertising, operate a sports trivia program, or any other requests that may be programmed into the controller 82. It is to be expressly understood that other types of interfaces or controllers may be used to operate the system of the present invention.

Another preferred embodiment of the present invention provides a multi-media fantasy sports league manager system. The system of this preferred embodiment utilizes a server based system that manages the functions of the fantasy league. For example, the scores of each competition are calculated and a winner is declared. The standings of the league are automatically updated. The rosters of the teams are maintained, and any trades, waivers, or pick-ups are updated with information sent to each team owner. The news relating to the league, teams and players is transmitted to each team owner. Statistics on each player and team are automatically updated and sent to each team owner.

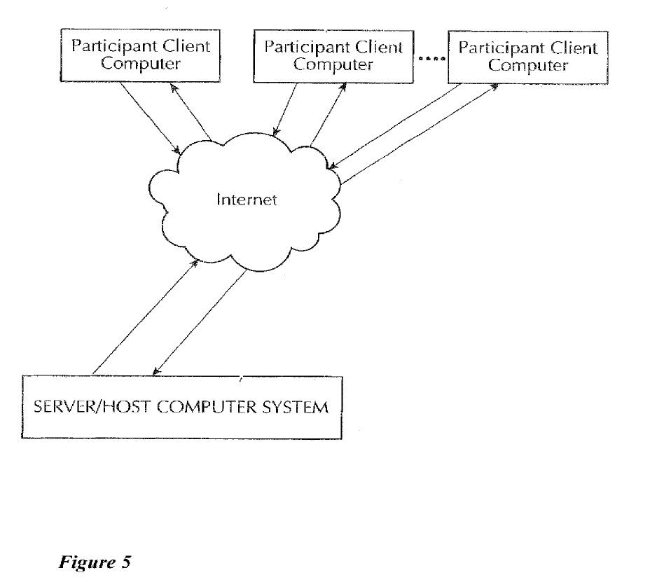

The server based system may be accessed via the Internet, by networks, intranets, satellite based systems or any other type of network system. The users, that is the team owners and administrators, can easily access the server to receive and transmit information. Information may also be transmitted by email, instant messaging or any other type of messaging system. A schematic of an example of such a system is illustrated in FIG. 5.

A further enhancement of a preferred embodiment of the present invention is the use of on-demand media highlights. The server based league manager is able to retrieve highlights on the players for the entire league during the season, and particularly in near time of the actual competition. The team owners may then retrieve these highlights for the players for their team for evaluation and entertainment. The team owners are able to retrieve only the highlights that they request. These highlights may be available in a number of formats, including streaming video, audio, print, or any other type of format available.

The team owners can then conduct film sessions of their players. The players performance can be evaluated by more than just print statistics. It also allows the owners to view highlights or mistakes that they may have previously missed, or relive favorite moments. These film sessions are provided on-demand at the convenience of the owner.

These film sessions or other media clips may also be embedded with advertisements as well. This provides yet another source of revenue for the league administrators or for commercial versions of this system.

These and other features are provided in the present invention. As discussed above, these descriptive embodiments are provided for explanatory purposes and are not meant to limit the scope of the claimed inventions.

1. A system for providing multi-media enhancement of a fantasy league draft proceeding, said system comprising:
a medium for conducting a fantasy league draft proceeding;
a media viewer for viewing multi-media;
a database for storing medium relating to the fantasy league draft proceeding; and
a controller for associating said medium from said database with said fantasy league draft proceeding for viewing in said media viewer.

2. The system of claim 1 wherein said medium includes:
a display providing information regarding the draft proceeding; and
said media viewer displayed on said display.

3. The system of claim 1 wherein said medium includes:
audio and video clips.

4. The system of claim 1 wherein said medium includes:
information relating to players selectable in said fantasy league draft proceeding.

5. The system of claim 1 wherein said medium includes:
entertainment medium for viewing between selections of said fantasy league draft proceeding.

6. The system of claim 1 wherein said medium includes:
advertisements for viewing on said media viewer.

7. The system of claim 1 wherein said system is incorporated onto a removable media format.

8. The system of claim 1 wherein said system is a server based network system.

9. The system of claim 1 wherein said system is a wireless server based network system.

10. The system of claim 1 wherein said system is a server based network system; and
each user is able to access said system via a hand held wireless device.

11. The system of claim 1 wherein said system is incorporated in a television based system.

12. The system of claim 1 wherein said system is utilized in an electronic gaming technology.

13. The system of claim 1 wherein said system further includes:
an on-demand delivery system for providing multi-media files to each team owner on an updated basis regarding the players selected by that team owner during said fantasy league draft proceeding.

14. The system of claim 1 wherein said system further includes:
said controller and said database operated by a computer system.

15. A system for managing a fantasy league having fantasy teams, fantasy team owners and players associated with each fantasy team, said system comprising:
an on-demand delivery system for providing multi-media files for each team owner on a periodic basis for evaluating each player of the team owned by that team owner.

16. The system of claim 15 wherein said system includes:
a server for hosting said system;
client interfaces for allowing each of said team owners to access said system on said server to retrieve the multi-media files on an on-demand basis.

17. The system of claim 15 wherein said system includes:
a medium for conducting a fantasy league draft proceeding;
a media viewer for viewing multi-media;
a database for storing medium relating to the fantasy league draft proceeding; and
a controller for associating said medium from said database with said fantasy league draft proceeding for viewing in said media viewer.

18. The system of claim 17 wherein said medium includes:
a display; and
said media viewer displayed on said display.

19. The system of claim 17 wherein said medium includes:
audio and video clips.

20. The system of claim 17 wherein said medium includes:
information relating to players selectable in said fantasy league draft proceeding.

21. The system of claim 17 wherein said medium includes:
entertainment medium for viewing between selections of said fantasy league draft proceeding.

22. The system of claim 17 wherein said medium includes:
advertisements for viewing on said media viewer.

23. A method for conducting a fantasy league draft proceeding, said method comprising the steps of:
providing a viewable display of the draft proceeding;
providing a media viewer on said viewable display; and
providing a multi-media display on said media viewer associated with the draft proceeding.

24. The method of claim 23 wherein said step of providing a multi-media display includes:
providing a database having multi-media files relating to the players to be chosen in the draft proceeding; and
providing a mechanism for associating the draft proceedings with said database to display said multi-media files relating to particular players at selected moments during the draft proceeding.

25. The method of claim 23 wherein said step of providing a multi-media display includes:
providing a database having multi-media files relating to the players to be chosen in the draft proceeding and other information of interest during the draft proceeding; and
providing a mechanism for associating the draft proceedings with said database to display said multi-media files relating to particular players as well as said other information at selected moments during the draft proceeding.
